(19) United States
(12) Patent Application Publication
(10) Pub. No.: US 2008/0045101 A1
(43) Pub. Date: Feb. 21, 2008

(54) Decorative dual scrim composite panel

(76) Inventors: Shannon D. Near, Grand Rapids, MI (US); Kenneth P. Kastner, Jenison, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/506,319

(22) Filed: Aug. 18, 2006

(51) Int. Cl. B32B 5/26; B32B 27/12; B32B 27/04

(52) U.S. Cl. 442/35; 442/38; 442/41; 442/361; 442/149; 442/394

(57) ABSTRACT

A decorative, lightweight panel structure that is adaptable for use as interior ceiling panels, interior wall panels, and exterior sheathing or siding, which exhibits excellent rigidity, and which can be made to exhibit a combination of good sound attenuation property, excellent aesthetic appearance, uniformity of aesthetic quality, outstanding weatherability, and/or low manufacturing cost, includes a non-woven fibrous batt comprised of thermoplastic fibers, a scrim layer bonded to each of two opposite sides of the non-woven fibrous batt, and a decorative film layer having a surface indicia on an exterior side and an opposite interior side bonded to one of the scrim layers.

### FIELD OF THE INVENTION

This invention relates to the field of decorative building paneling, and more particularly to decorative ceiling panels, wall panels and exterior wall sheathing panels.

### BACKGROUND OF THE INVENTION

In the field of building panels, encompassing ceiling tiles or panels, interior wall panels, and exterior wall sheathing or siding, there have been many attempts to provide low cost, decorative simulated wood, marble, granite, and the like. Conventional exterior sheathing has generally been limited to relatively heavy panels in which genuine brick, stone or the like is cut into thin slabs which are either adhered directly to a wall, such as a concrete wall, or mounted on a substrate that is attached to the wall; or more lightweight materials, such as vinyl and aluminum siding, which have only provided a relatively limited variety of simulated decorative styles, typically simulated wood planks. Simulated wood, marble and granite panels for interior wall applications have generally been limited to laminates comprising a plywood, particleboard, or other composite wood backing on which is laminated a decorative facing layer. Such interior wall paneling has generally been relatively heavy, making transportation and insulation of the paneling difficult. Ceiling tiles or panels have generally included an acoustically absorbent inner core, a backing material for enhancing panel strength, and a front facing for enhancing the aesthetic appearance of the panel. Typically, the inner core may comprise fiberglass batts formed from resin impregnated fiberglass, wet-laid mineral, slag mineral, cellulose fibers, or combinations thereof, and may include a variety of inorganic fillers such as perlite, clays and/or gypsum. These panels are often relatively heavy, and are sometimes subject to deformation.

### SUMMARY OF THE INVENTION

The invention provides a lightweight panel structure that is adaptable for use as interior ceiling panels, interior wall panels, and exterior sheathing or siding. The panel structures of this invention also exhibit excellent rigidity, and can be made to exhibit a combination of good sound attenuation properties, excellent aesthetic appearance, uniformity of aesthetic quality, outstanding weatherability, and/or a low manufacturing cost.

The decorative composites of this invention, which in certain embodiments may be suitable for use as ceiling panels, interior wall panels, and exterior sheathing, include a non-woven fibrous batt comprised of thermoplastic fibers; a scrim layer bonded to each of two opposite sides of the non-woven fibrous batt; and a decorative film layer having a surface indicia on an exterior side and an opposite interior side bonded to one of the scrim layers.

In accordance with another aspect of the invention, the decorative composite panel of this invention are made by providing a core layer configured from non-woven fibers, in which at least some of the fibers comprise a heat-activated resin; providing first and second scrim layers; positioning the first and second scrim layers overlying opposite faces of the core layer in a stacked relationship to define a composite assembly; heating the composite assembly to a temperature which causes the heat activatable resin in the core layer to bond with the first and second scrim layers; providing a decorative film layer having indicia applied to the exterior face thereof; and adhering an interior face of the decorative film to an exterior face of one of the first and second scrim layers to define the decorative panel.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a bottom view of a ceiling panel in accordance with the inventions.

FIG. 2 is a cross-sectional view of an edge of the ceiling panel shown in FIG. 1.

FIG. 3 is a perspective view of a corner of the ceiling panel shown in FIGS. 1 and 2.

FIG. 4 is a bottom plan view of a corner of the ceiling panel shown in FIGS. 1-3.

FIG. 5 is an enlarged cross-sectional view of an edge of a ceiling panel according to the invention supported on a ceiling grid railing.

### DETAILED DESCRIPTION OF PREFERRED EMBODIMENTS

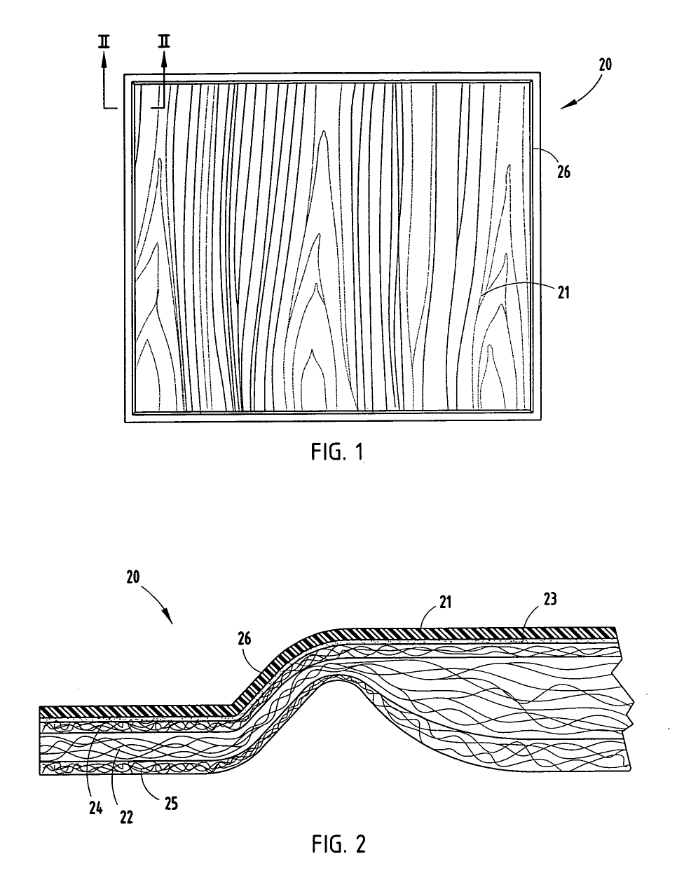

A decorative composite panel 20 (FIG. 1) includes a decorative film layer 21 having surface indicia on its exterior side. In the illustrated embodiment, the surface indicia is a simulated wood grain. However, simulated marble, granite and other surface indicia are contemplated. The decorative film 21 is bonded to a substrate comprising a non-woven fibrous batt 22 comprised of thermoplastic fibers. Bonded to each of the two opposite sides of non-woven fibrous batt 22 are scrim layers 24 and 25.

The decorative film layer 21 typically consists of a vinyl polymer or copolymer such as polyvinylchloride, polyester, polyurethane, polyolefin or other polymeric film on which a desired decorative indicia is printed. If desired, other layers of material may be applied over the printed film layer for various reasons that may include scratch resistance, abrasion resistance, graffiti resistance, added depth to the top layer appearance, a carrier for anti-microbial agents, weather resistance, stain resistance and sound deadening. The printed indicia may simulate various building materials, including, but not limited to, wood grain patterns of all species of wood, stone, rock, leather, any type of painted surface, gold leaf, plated surfaces, graphite, dyed surfaces, plated silver, powder coated surfaces, and minerals. Any type of material that can be simulated on a printed material may be used. The printed material is typically produced in various ways to add significant realism to the appearance of the laminate material to promote flexibility of the surface without degradation of the appearance. Manufacturing techniques used to produce the printed material include folding, bellowing, and pre-saturating to allow the material to be formed and shaped without separation of the printing that might result in a degradation appearance of the material. Typically, the decorative film layer is from about 6 mils to about 40 mils thick, and more typically from about 6 mils to about 20 mils thick.

One way to add significant realism to the appearance of the surface indicia on the decorative film layer is to photograph a pattern from more than one position. These images are then recorded on a computer and used to etch a series of chrome cylinders which emboss the grain or texture into the printed material. After embossing, a coloring agent may optionally be added to the grain, adding realism and depth. This printing process is useful for any type of decorative pattern, including the multitude of wood grain patterns of different species of wood. This printing process, and any other known to one of ordinary skill in the art, can be performed on any suitable decorative layer, including printed polyvinylchloride, polyester, polyurethane, etc.

Non-woven batt 22 may be comprised of generally any combination of synthetic, natural and/or mineral fibers, provided that the non-woven fibrous layer 22 includes a sufficient quantity of heat activatable thermoplastic fibrous that will provide desirable shape retention properties to the non-woven layer 22 and resulting composite panel 20 upon heating to a temperature at or above the activation temperature of the heat activatable fibers and subsequent cooling in a thermoforming shaping process. Suitable heat activatable thermoplastic fibers include various fibers that can be softened and/or partially melted upon application of heat during a thermoforming process to form a multiplicity of bonds at fiber-fiber intersections to impart shape retention properties. Examples of suitable heat activatable thermoplastic fibers include those comprised of homopolymers and copolymers of polyester, nylon, polyethylene, polypropylene and blends of fibers formed from these polymers and copolymers. Particularly suitable are composite or bi-component fibers having a relatively low melting binder component and a higher melting strength component. Bi-component fibers of this type are advantageous since the strength component imparts and maintains adequate strength to the fiber while the bonding characteristics are imparted by the low temperature component. A variety of bi-component fibers of this type are commercially available from various sources. One suitable fiber for use in the present invention is a sheath-core bi-component structure wherein the core is formed of a relatively high melting polyethylene terephthalate (PET) polymer and the sheath comprises a PET copolymer having a lower melting temperature which exhibits thermoplastic adhesive and thermoformability properties when heated to a temperature of about 185° F. to 210° F. The amount of heat activatable fiber in non-woven fibrous batt 22 is selected to provide the desired shape retention properties for a particular panel structure used in a particular application. Typically, non-woven fibrous batt 22 comprises at least about 10% heat activatable thermoplastic fibers by weight. There is no upper limit to the amount of heat activatable fibers that may be utilized in the non-woven fibrous batt. However, because heat activatable fibers are typically more expensive than other synthetic, natural and/or mineral fibers, it is typically desirable to use only the amount of heat activatable thermoplastic fiber that is needed to achieve the desired shape retention properties and rigidity required for the finished decorative composite panel. Typically, the amount of heat activatable fiber in non-woven fibrous batt 22 is from about 10% to about 50% by weight of the fibrous batt 22.

In order to reduce cost, non-heat activatable synthetic fibers, natural fibers, and/or mineral fibers may be utilized in non-woven fibrous batt 22 in amounts typically ranging from about 50% to about 95% of the weight of fibrous batt 22. As with the heat-activatable fibers, the non-heat activatable synthetic fibers may be comprised of homopolymers and copolymers or polyester, nylon, polyethylene, propylene, etc., and blends of fibers formed from these polymers and copolymers. Natural fibers that may be employed include kenaf, grasses, rice hulls, bagasse, cotton, jute, hemp, flax, bamboo, sisal, abaca and wood fibers. Examples of mineral fibers include glass, ceramic and metal fibers. However, mineral fibers are generally not preferred, especially in relatively high qualities, as they may tend to undesirably add weight to the decorative composite panels.

The scrim layers 24, 25 are lightweight fabrics that are not lofted or have a very low loft. In general, unlike the non-woven fibrous batt 22, which is a lofted fabric having relatively randomly oriented fibers, scrim layers 24, 25 have essentially no vertically oriented fibers (i.e., fibers that extend perpendicular to the plane of the scrim fabric sheet). Instead, substantially all of the fibers in scrim layers 24, 25 are oriented within the plane of the fabric sheet. Scrim layers 24, 25 may be comprised of generally any combination of synthetic, natural and mineral fibers, and may be either woven or non-woven. Scrim layers 24, 25 may also be distinguished from non-woven fibrous batt 22 by their thicknesses and/or basis weights. More specifically, the scrim layers 24, 25 typically have a thickness in the range of from 0.5 to 1.5 millimeters and a basis weight (weight per unit area of fabric) in the range of 20 to 40 grams per square foot, whereas the non-woven fibrous batt or core layer 22 typically has a basis weight in the range of 60 to 120 grams per square foot, and typically has a thickness in the range of 8 to 12 millimeters prior to thermoforming, and a thickness in the range of from 4 to 6 millimeters in the finished decorative composite panel after thermoforming.

During the thermoforming process, scrim layers 24, 25 are bonded to core layer 22. This bonding can be achieved by fiber-fiber bonding of fibers at the interfaces between the core layer 22 and scrim layers 24, 25. In some cases, fusion of heat-activated fibers of core layer 22 with fibers of scrim layers 24, 25 at the interfaces of the layers will provide sufficient adhesion. In other cases, it may be desirable to utilize an adhesive for bonding scrim layers 24, 25 to core layer 22. Adhesives for bonding scrim layers 24, 25 to core layer 22 may comprise a thin heat-activatable thermoplastic film that is disposed between each of the scrim layers 24, 25 and the opposite sides of core layer 22, and which melts and subsequently fuses the layers together during a thermoforming process. A preferred adhesive is a low temperature reactive polyurethane resin (PUR). Alternatively, various thermosetting resin compositions may be sprayed, brushed, roll-coated or otherwise deposited between scrim layers 24 and the opposite sides of core layer 22. Examples include polyamides, polyepoxides, reactive polyurethane resins, etc., which desirably cure upon application of heat during a thermoforming process in which the heat-activatable fibers in core layer 22 are simultaneously or contemporaneously activated and subsequently fused to provide shape retention of the composite.

The resulting three-layer composite is a relatively thin (about 5 to 10 millimeters), lightweight (about 100 to 200 grams per square foot) composite that exhibits exceptional rigidity. The scrim layers 24, 25 bonded on opposite sides of core layer 22 very dramatically increase the bending strength of the composite without adding significant thickness or weight to the composite.

While it is conceivable that decorative film layer 21 could be bonded to one of the scrim layers 24, 25 during the thermoforming process, it is generally more desirable to adhesively bond film layer 21 to a pre-formed composite comprising scrim layers 24, 25 bonded to core layer 22. More specifically, it has been determined that it is desirable to pre-form a composite assembly comprising scrim layers 24, 25 bonded to core layer 22 using a relatively higher temperature thermoforming process (e.g., 185-210° F.) with heat activatable fibers that are activated at these relatively higher temperatures, and to bond the decorative film layer 21 to the pre-formed composite using an adhesive layer 23 comprising a heat activatable resin that melts, becomes tacky or cures at a relatively low temperature (e.g., 150-180° F.).

This two-step process provides an extremely smooth decorative surface, without impressions from the underlying fibers that may occur when all of the layers of the composite are bonded and formed together in a single operation.

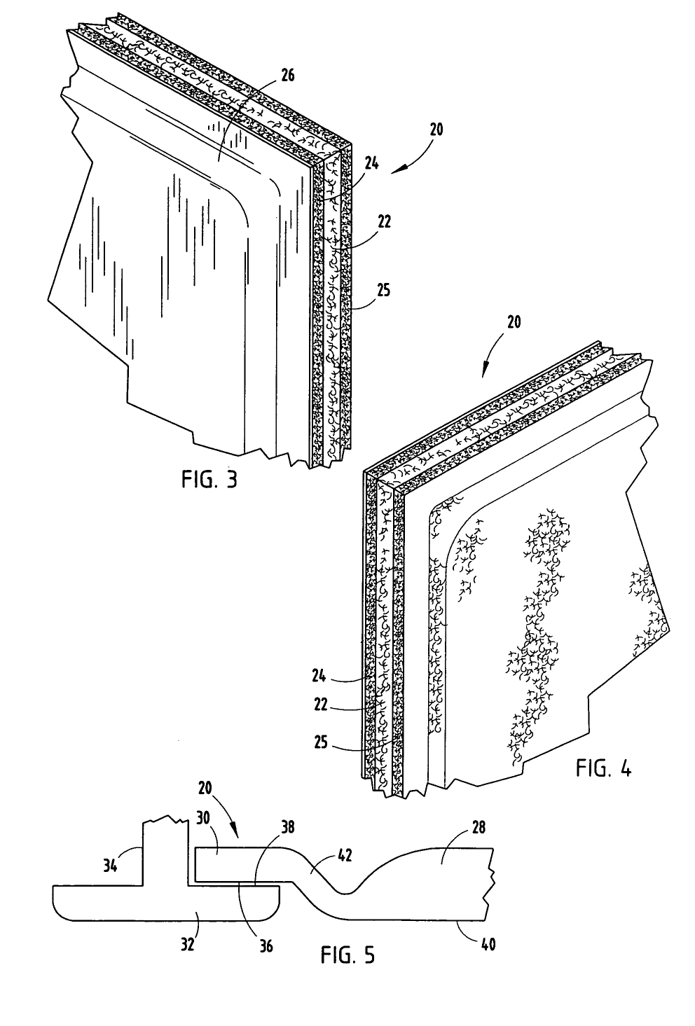

As shown in FIGS. 3 and 4, the decorative composite panels of this invention can be shaped to have contours (i.e., non-planar surfaces), such as beveled edges 26, and variable thickness and density. For examples, in the illustrated embodiment, the beveled edges are more compressed, and therefore are denser and more rigid to provide added strength to prevent sag in ceiling applications.

For indoor applications such as for ceiling tiles and/or wall panels, decorative film layer 21 may be provided with microperforations to impart improved sound absorption characteristics. Preferably, the micrperforations are made prior to attachment of film layer 21 to the composite structure. Techniques for making microperforations in a polymer film are well known. Preferably, the microperforations are substantially invisible, and do not detract from the aesthetic effect of the decorative printed indicia.

The decorative panels of this invention may be made by providing a core layer configured from non-woven fibers, preferably in which at least some of the fibers comprise a heat activatable resin, providing first and second scrim layers, positioning the scrim layers overlying opposite faces of the core layer in a stacked relationship to define a composite assembly, optionally disposing an adhesive between each of the scrim layers and the core layer, heating the composite assembly to a temperature which causes the heat activatable resin in the core layer to bond with adjacent fibers in the core layer and/or which causes the core layer to bond with the first and second scrim layers, providing a decorative film layer having indicia applied to the exterior face thereof, and adhering an interior face of the decorative film to an exterior face of one of the first and second scrim layers to define a decorative panel.

As a particular example, a cover panel for building construction and the like can be prepared using the method generally outlined above, wherein the core layer is configured from non-woven synthetic fibers having a heat activated resin, a thickness in the range of 4-12 millimeters, and a surface density (basis weight) in the range of 60-120 grams per square foot; and scrims layers configured from woven or non-woven synthetic fibers, having or not having a heat-activated resin, each of the scrim layers having a thickness in the range of 0.5-1.5 millimeters and a surface density (basis weight) in the range of 20-40 grams per square foot. In certain embodiments, such as for ceiling tiles, the composite assembly may be selectively compressed while being heated so that the first and second scrim layers adhere to the opposite faces of the core layer and define a lightweight, rigid, substrate having a lofted central portion with a thickness in the range of 8-12 millimeters and an inelastically compressed marginal portion with a thickness in the range of 4-6 millimeters to define a rigid support edge.

In accordance with another specific embodiment, ceiling tiles in accordance with the invention may be prepared generally as outlined above, using a core layer configured from non-woven PET synthetic fibers with a heat-activated resin, and wherein the core layer has thickness in the range of 4-12 millimeters and a surface density (basis weight) in the range of 60-120 grams per square foot, and wherein the first and second scrim layers are configured from non-woven PET synthetic fibers with a heat-activated resin, and wherein each of the scrim layers has a thickness in the range of 0.5-1.5 millimeters and a surface density (basis weight) in range of 20-40 grams per square foot. As with the previously described example, the scrim layers are overlying opposite faces of the core layer in a vertically stacked relationship to define a composite assembly, heated to a temperature which causes the heat activatable resin in the core layer to become tacky and/or melt and subsequently bond with adjacent fibers in the core layer and, optionally in the scrim layers, and selectively compressed while heated to adhere the first and second scrim layers to the opposite faces of the core layer and define a lightweight, rigid, tile substrate having a lofted central portion with a thickness in the range of 8-12 millimeters to attenuate sound transmission, and an inelastically compressed marginal portion with a thickness in the range of 4-6 millimeters to define a rigid hanger edge from which the tile is supported. The resulting hanger edge 30 (shown in FIG. 5) allows ceiling tile 20 to be supported on an upper surface of a support flange 32 of a ceiling grid support rail 34. In the illustrated embodiment, support edge 30 has a bottom downwardly facing surface 36 bearing upon an upwardly facing surface 38 of flange 32, with downwardly facing surface 36 being offset from and substantially parallel with exterior face 40 of the central lofted portion of panel 20. Ceiling panel 20 shown in FIG. 5 also includes an angled leg 42 that extends from the central lofted portion 28 of panel 20 to the rigid support edge 30 of panel 20. Angled leg 42 transitions between the higher density, lower loft, more rigid hanger edge portion 30 to the higher loft, lower density, sound attenuating central portion 28, and therefore has a variable thickness, density, and loft. Thus, in accordance with another aspect of the invention, there is provided a suspended ceiling for a building comprising a hanger grid and ceiling panels as illustrated in FIG. 5 supported on the grid.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A decorative composite comprising:
a non-woven fibrous batt comprised of thermoplastic fibers;
a scrim layer bonded to each of two opposite sides of the non-woven fibrous batt; and
a decorative film layer having surface indicia on an exterior side, and an opposite interior side bonded to one of the scrim layers.

2. A decorative composite of claim 1, wherein the film layer is a polymer film.

3. A decorative composite of claim 1, wherein the film layer is a vinyl polymer or copolymer.

4. A decorative composite of claim 1, wherein the film layer is a comprised of a polyester, polyurethane or polyolefin.

5. A decorative composite of claim 1, wherein the decorative film layer has a thickness of from about 6 mils to about 40 mils.

6. A decorative composite of claim 1, wherein the non-woven fibrous batt is comprised of a blend of synthetic and natural fibers.

7. A decorative composite of claim 1, wherein the non-woven fibrous batt is comprised of a blend of synthetic and mineral fibers.

8. A decorative composite of claim 1, wherein the non-woven fibrous batt is comprised of a blend of synthetic, natural and mineral fibers.

9. A decorative composite of claim 1, wherein the thermoplastic fibers of the non-woven fibrous batt include fibers comprising a heat activatable resin.

10. A decorative composite of claim 1, wherein the thermoplastic fibers of the non-woven fibrous batt include bi-component fibers having a heat activatable component that melts at a lower temperature than a second component.

11. A decorative composite of claim 10, wherein the bi-component fiber has a sheath-core structure.

12. A decorative composite of claim 11, wherein the sheath has a melting temperature of from about 185° F. to about 210° F.

13. A decorative composite of claim 1, wherein the sheath is comprised of a polyethylene terephthalate copolymer.

14. A decorative composite of claim 1, wherein the non-woven fibrous batt comprises from 10% to 50% heat activatable fibers.

15. A decorative composite of claim 1, wherein the scrim has a thickness of from 0.5 to 1.5 millimeters and a basis weight of from 20 to 40 g/ft².

16. A decorative composite of claim 1, wherein the scrim layers are bonded to the non-woven fibrous batt by fiber-to-fiber bonding at the interfaces between the non-woven fibrous batt and the scrim layers.

17. A decorative composite of claim 1, wherein the scrim layers are bonded to the non-woven fibrous batt with an adhesive disposed between the non-woven fibrous batt and the scrim layers.

18. A decorative composite of claim 17, wherein the adhesive is a thermoset resin.

19. A decorative composite of claim 17, wherein the adhesive comprises a reactive polyurethane resin.

20. A decorative composite of claim 1, which is shaped to have non-planar contours.

21. A decorative composite of claim 1, which has beveled edges.

22. A decorative composite of claim 1, which has variable thicknesses and densities.

23. A decorative composite of claim 1, wherein the decorative film layer is microperforated to enhance acoustic property.

24. A method for making a decorative panel, comprising:
providing a core layer configured from non-woven fibers at least some of the fibers comprising a heat activatable resin;
providing first and second scrim layers;
positioning the first and second scrim layers overlying opposite faces of the core layer in a stacked relationship to define a composite assembly;
heating the composite assembly to a temperature which causes the heat activatable resin in the core layer to bond with the first and second scrim layers;
providing a decorative film layer having indicia applied to the exterior face thereof; and
adhering an interior face of the decorative film to an exterior face of one of the first and second scrim layers to define a decorative panel.

25. A method for making a cover panel for building construction and the like, comprising:
providing a core layer configured from non-woven synthetic fibers with a heat-activated resin, and having a thickness in the range of 4-12 mm, and a surface density in the range of 60-120 g/ft²;
providing first and second scrim layers configured from non-woven synthetic fibers with a heat-activated resin, and each having a thickness in the range of 0.5-1.5 mm and a surface density in the range of 20-40 g/ft²;
positioning the first and second scrim layers overlying opposite faces of the core layer in a stacked relationship to define a composite assembly;
heating the composite assembly to a temperature which causes the resin in the core layer and the first and second scrim layers to adhere to adjacent fibers;
selectively compressing the heated composite assembly to adhere the first and second scrim layers to the opposite faces of the core layer and define a lightweight, yet rigid, substrate having a lofted central portion with a thickness in the range of 8-12 mm, and an inelastically compressed marginal portion with a thickness in the range of 4-6 mm to define a rigid support edge;
providing a decorative film layer having indicia applied to the exterior face thereof; and
adhering the interior face of the decorative film to the exterior face of one of the first and second scrim layers to define a cover panel with a decorative exterior surface.

26. A method for making ceiling tiles and the like, comprising:
providing a core layer configured from non-woven PET synthetic fibers with a heat-activated resin, and having a thickness in the range of 4-12 mm, and a surface density in the range of 60-120 g/ft²;
providing first and second scrim layers configured from non-woven PET synthetic fibers with a heat-activated resin, and each having a thickness in the range of 0.5-1.5 mm and a surface density in the range of 20-40 g/ft²;
positioning the first and second scrim layers overlying opposite faces of the core layer in a vertically stacked relationship to define a composite assembly;
heating the composite assembly to a temperature which causes the resin in the core layer and the first and second scrim layers to adhere to adjacent fibers;
selectively compressing the heated composite assembly to adhere the first and second scrim layers to the opposite faces of the core layer and define a lightweight, yet rigid, tile substrate having a lofted central portion with a thickness in the range of 8-12 mm to attenuate sound transmission, and an inelastically compressed marginal portion with a thickness in the range of 4-6 mm to define a rigid hanger edge from which the tile is supported;
providing a decorative film layer having indicia applied to the exterior face thereof; and
adhering the interior face of the decorative film to the exterior face of one of the first and second scrim layers to define a ceiling tile with a decorative exterior surface.
